(19) United States
(12) Patent Application Publication
(10) Pub. No.: US 2010/0100534 A1
(43) Pub. Date: Apr. 22, 2010

(54) Ticker uploader for eBay®

(76) Inventor: Monir Sharif Sider, Arlington, VA (US)

Correspondence Address: MONIR SIDER, 831 SOUTH IVY STREET, ARLINGTON, VA, 22204, US

(21) Appl. No.: 12/290,826

(22) Filed: Nov. 4, 2008

Related U.S. Application Data
(60) Provisional application No. 60/990,267, filed on Nov. 26, 2007.

(51) Int. Cl. G06F 7/00; G06F 9/44; G06F 15/16

(52) U.S. Cl. 707/702; 719/328; 709/219

(57) ABSTRACT

A method for automatically uploading information to an eBay® server includes the steps of: (a) receiving in a parsing server a formatted electronic file containing information about at least one of product information including event ticket information and other product information, and service information; (b) translating the formatted electronic file within the parsing server into a format that is compatible with eBay® API to provide a compatible parsed data file using a dynamic programming language; and (c) automatically uploading the compatible parsed data file to an eBay® server. The method also updates any existing event tickets or products or services that have been uploaded to eBay® previously using this method.

### CROSS REFERENCE TO RELATED APPLICATION(S)

This application claims the benefit of priority from Provisional Application Ser. No. 60/990,267 entitled Ticket Uploader for EBay® filed—Nov. 26, 2007.

### BACKGROUND OF THE INVENTION

1. Field of the Invention

The present invention relates to a ticket uploader for eBay®.

2. Description of the Related Art

The object of the present invention is to automate the process of uploading event tickets or any other product or service to eBay®.

### SUMMARY OF THE INVENTION

The objective of the present invention is to automate the process of uploading event tickets or any other product or service to eBay®. Using the eBay® development API, a file can be uploaded in CSV, txt, XML or any other format, which automatically populates the event tickets or any other product or service specified in the formatted file being offered by the uploading user on eBay®. This process also updates any existing event tickets or products and services that have been uploaded to eBay® previously using the Ticket Uploader for eBay®.

### BRIEF DESCRIPTION OF THE DRAWING

FIG. 1 is a diagram of the system and method of the present invention.

### DETAILED DESCRIPTION OF THE INVENTION

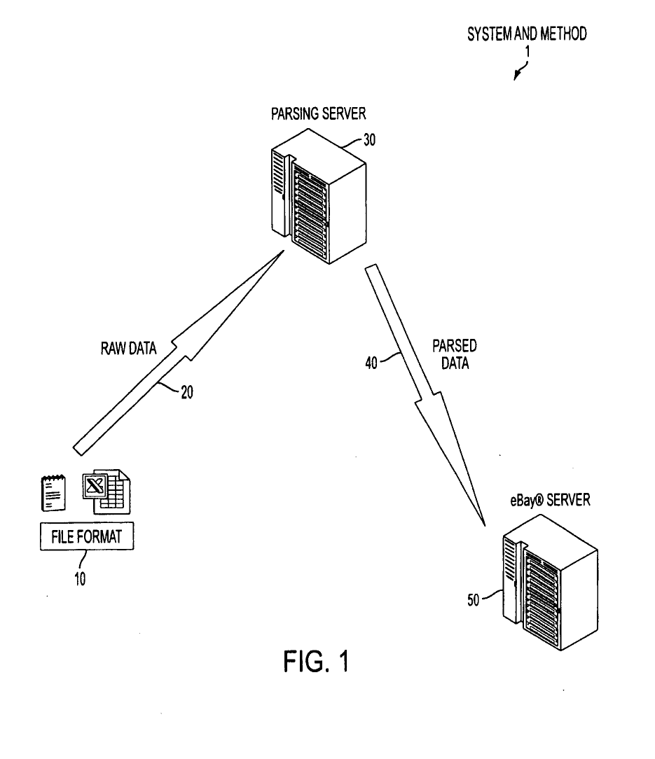

As shown in FIG. 1, the system and method of the invention 1 is comprised of the following components:
(1) CSV, txt, XML or any other file format 10 that is uploaded (see Raw Data arrow 20) to a parsing server 30;
(2) Uploaded CSV, txt, XML or any other file format 10 is automatically parsed using a script which is running on the parsing server 30;
(3) Parsed data (see Parsed Data arrow 40) is automatically sent into an eBay® server 50 via a script running on the parsing server 30;
(4) It is made using a dynamic programming language, database structures and also eBay® API; and
(5) It also works for any other product or services that you would like to upload to eBay®.

Ticket Uploader for eBay® is used to automatically upload event tickets or any other product or services to eBay® and to manage updates to those event tickets or products or services as well. By using a dynamic programming language to translate CSV, txt, XML or any other formatted files into a format that is compatible with the eBay® API.

Ticket Uploader For eBay® is an automated eBay® uploader which means that the user uploads their file containing their inventory into the parsing server, the parsing server then communicates to eBay® API, and then the user's inventory is placed into their eBay® account on the fly. Once the user uploads another file the parsing server recognize that there has been changes and makes the necessary changes to the eBay® user account.

Ticket Uploader For eBay® use CSV, txt, XML, or any other formatted file that is uploaded to the parsing server to get parsed and then the format is checked to see if the format is correct. Once it recognizes that the format is correct, it loads up into a database in the parsing server on the fly and then goes straight to the user's eBay® account by means of linking from our server to eBay® API to the user's eBay® account.

Also, every time the eBay® user uploads another file to our server that is a CSV, txt, XML or any other formatted file, our server recognizes the changes, if any changes were made, and will then automatically send the eBay® user a confirmation notifying that the changes were made for that eBay® user's account.

1-4. (canceled)

5. A method for automatically uploading information to an eBay® server, including product information and service information, the method comprising the steps of:
a. receiving in a parsing server a formatted electronic tile containing information about at least one of product information including event ticket information and other product information, and service information;
b. translating the formatted electronic file within the parsing server into a format that is compatible with eBay® API to provide a compatible parsed data file using a dynamic programming language; and
c. automatically uploading the compatible parsed data file to an eBay® server.

6. The method according to claim 5, wherein the information is event ticket information and the method for automatically uploading information to an eBay® server is a ticket uploader method for automated eBay® uploading.

7. The method according to claim 5, wherein step (a) receiving in a parsing server a formatted electronic file includes uploading by a user who has an eBay® account a formatted electronic file containing inventory data into the parsing server, and wherein step (c) automatically uploading the compatible parsed data file to an eBay® server includes (i) communicating the compatible parsed data file from the parsing server to the eBay® server and (ii) placing the compatible parsed data file containing the user's inventory data into the user's eBay® account automatically on the fly.

8. The method according to claim 5, wherein step (a) receiving in a parsing server a formatted electronic file includes uploading by a user who has an eBay® account a formatted electronic file containing inventory data into the parsing server, wherein step (b) translating the formatted electronic file within the parsing server into a format that is compatible with eBay® API to provide a compatible parsed data file using a dynamic programming language includes checking the compatible parsed data file to verify that the format thereof is a format that is compatible with eBay® API, followed by further translating if not compatible or uploading the compatible parsed data file to a database within the parsing server if compatible, and wherein step (c) automatically uploading the compatible parsed data file to an eBay® server includes (i) linking to communicate the compatible parsed data file from the database of the parsing server to the eBay® server and (ii) linking to place the compatible parsed data file containing the user's inventory data into the user's eBay® account automatically on the fly.

9. The method according to claim 5, further comprising the steps of:
d. receiving in the parsing server an updated formatted electronic file containing information about at least one of product information including event ticket information, and service information; and
e. translating the updated formatted electronic file within the parsing server into a format that is compatible with eBay® API to provide an updated compatible parsed data file using the dynamic programming language; and
f. automatically uploading the updated compatible parsed data file to the eBay® server.

10. The method according to claim 9, wherein step (a) receiving in a parsing server a formatted electronic file includes uploading by a user who has an eBay® account a formatted electronic file containing inventory data into the parsing server, wherein step (d) receiving in the parsing server an updated formatted electronic file includes recognition by the parsing server that the formatted electronic file is an updated formatted electronic file, and wherein step (f) automatically uploading the updated compatible parsed data file to an eBay® server includes (i) communicating the updated compatible parsed data file from the parsing server to the eBay® server and (ii) placing the updated compatible parsed data file containing the user's inventory data into the user's eBay® account automatically on the fly.

11. The method according to claim 10, further comprising the step of (g) sending the user a confirmation that the user's eBay® account has been updated.

12. The method according to claim 9, wherein the information is event ticket inventory information and the method for automatically uploading information to an eBay® server is a ticket uploader method for automated eBay® uploading and updating.

13. A system for automatically uploading information from a parsing server to an eBay® server, comprising:
a. a parsing server that receives a formatted electronic file containing information about at least one of product information including event ticket information and other product information, and service information;
b. a dynamic programming language stored within the parsing server that translates the formatted electronic file within the parsing server into a format that is compatible with an eBay® API to provide a compatible parsed data file; and
c. linking the parsing server to the eBay® server for automatically uploading the compatible parsed data file to the eBay® server.

14. The system according to claim 13, wherein the information is event ticket information and the event ticket information is automatically uploaded to the eBay® server.

15. The system according to claim 13, wherein the parsing server receives the formatted electronic file from a user who has an eBay® account and who uploads the formatted electronic file containing inventory data into the parsing server, and wherein automatically uploading the compatible parsed data file to the eBay® server includes (i) linking to communicate the compatible parsed data file from the parsing server to the eBay® server, and (ii) placing the compatible parsed data file containing the user's inventory data into the user's eBay® account automatically on the fly.

16. The system according to claim 13, wherein the parsing server receives the formatted electronic file from a user who has an eBay® account and who uploads the formatted electronic file containing inventory data into the parsing server, wherein the formatted electronic file is translated within the parsing server into a format that is compatible with eBay® API to provide a compatible parsed data file using the dynamic programming language and the compatible parsed data file is checked to verify that the format thereof is a format that is compatible with the eBay® API, followed by further translation if not compatible or uploading the compatible parsed data file to a database within the parsing server if compatible, and wherein automatically uploading the compatible parsed data file to the eBay® server includes (i) linking to communicate the compatible parsed data file from the database of the parsing server to the eBay® server and (ii) linking to place the compatible parsed data file containing the user's inventory data into the user's eBay® account automatically on the fly.

17. The system according to claim 13, further comprising:
d. the parsing server receives an updated formatted electronic file containing information about at least one of product information including event ticket information, and service information; and
e. the updated formatted electronic file is translated within the parsing server into a format that is compatible with eBay® API to provide an updated compatible parsed data file using the dynamic programming language; and
f. linking the parsing server to the eBay® server for automatically uploading the updated compatible parsed data file to the eBay® server.

18. The system according to claim 17, wherein the parsing server receives the formatted electronic file from a user who has an eBay® account and who uploads an updated the formatted electronic file containing inventory data into the parsing server, wherein the parsing server recognizes when the updated formatted electronic file is an updated formatted electronic file, wherein the updated formatted file is translated within the parsing server into a format that is compatible with eBay® API to provide an updated compatible parsed data file using the dynamic programming language, and wherein automatically uploading the updated compatible parsed data file to an eBay® server includes (i) linking to communicate the updated compatible parsed data file from the parsing server to the eBay® server and (ii) linking to place the updated compatible parsed data file containing the user's inventory data into the user's eBay® account automatically on the fly.

19. The system according to claim 18, further comprising (g) sending the user a confirmation that the user's eBay® account has been updated.

20. The system according to claim 17, wherein the information is event ticket inventory information and the event ticket information is automatically uploaded to the eBay® server.
